(19) United States
(12) Patent Application Publication
(10) Pub. No.: US 2014/0246424 A1
(43) Pub. Date: Sep. 4, 2014

(54) MICROWAVE HEAT TREATMENT APPARATUS AND PROCESSING METHOD

(71) Applicant: Tokyo Electron Limited, Tokyo (JP)

(72) Inventor: Kouji SHIMOMURA, Yamanashi (JP)

(73) Assignee: Tokyo Electron Limited, Tokyo (JP)

(21) Appl. No.: 14/177,393

(22) Filed: Feb. 11, 2014

(30) Foreign Application Priority Data
Mar. 1, 2013 (JP) 2013-040639

(51) Int. Cl. H05B 6/64

(52) U.S. Cl. CPC H05B 6/6402
USPC 219/686

(57) ABSTRACT

Disclosed are a microwave heat treatment apparatus and a processing method in which a purging process time may be reduced while suppressing a use amount of a purging gas with simple facilities. An internal space of the processing container 2 of the microwave heat treatment apparatus 1 is at least divided, by a partition 7 and a processing container 2, into a first chamber S1 in which a wafer W is accommodated and a second chamber S2 into which the purging gas is directly introduced by the gas introducing unit 26. The purging gas is introduced from the gas introducing unit 26 into the second chamber S2 to diffuse the purging gas from the second chamber S2 into the first chamber S1 through a plurality of gas holes 7a of the partition 7 to purge atmosphere of the first chamber S1.

### CROSS-REFERENCE TO RELATED APPLICATIONS

This application is based on and claims priority from Japanese Patent Application No. 2013-040639, filed on Mar. 1, 2013 with the Japan Patent Office, the disclosure of which is incorporated herein in its entirety by reference.

### TECHNICAL FIELD

The present disclosure relates to a microwave heat treatment apparatus which introduces microwaves into a processing container to perform a predetermined processing and a processing method in which a target object to be processed is heated by using the microwave heat treatment apparatus.

### BACKGROUND

An apparatus using microwaves has recently been proposed as an apparatus performing an annealing process for a semiconductor wafer. As a heating apparatus using microwaves, for example, a heat treatment apparatus which includes an electromagnetic wave introduction unit for heating a substrate in an exhaustible processing container has been proposed in Japanese Patent Laid-Open Publication No. 2011-77065 (e.g., FIG. 1). Further, a microwave irradiation apparatus which includes an agitator for agitating microwaves and a partitioning plate for preventing particles which fall down from the agitator from being adhered on the substrate has been proposed in Japanese Patent Laid-Open Publication No. 2012-191158 (e.g., FIG. 1).

When a heat treatment is performed in a state where high concentration of oxygen exists within the processing container, a metal film on the substrate may be oxidized in the heat treatment apparatus. Therefore, a purging process for substituting atmosphere inside the processing container with an inert gas, such as N₂, and expelling the oxygen for each carrying-in/carrying-out operation of the substrate is performed in the heat treatment apparatus. Further, a mechanism for the purging process is not disclosed in the apparatuses of Japanese Patent Laid-Open Publication No. 2011-77065 (e.g., FIG. 1) and Japanese Patent Laid-Open Publication No. 2012-191158 (e.g., FIG. 1).

The purging process is generally performed each time when the substrate is replaced and thus, a time required for the purging process has a large effect on throughput of the substrate processing and affects productivity of a semiconductor apparatus. The time required for the purging process is mainly determined depending on (1) the volume of the processing container, (2) the pressure inside the processing container, and (3) the flow rate of a purging gas. Therefore, the above matters of (1) to (3) need to be considered in order to reduce the purging process time. However, as exemplified in Japanese Patent Laid-Open Publication No. 2011-77065 (e.g., FIG. 1) and Japanese Patent Laid-Open Publication No. 2012-191158 (e.g., FIG. 1), the shape or dimension of the processing container has an influence on the electromagnetic field distribution in the microwave heat treatment apparatus in which microwaves are irradiated to the substrate to perform the heat treatment and thus, changing design of the volume or the shape of the processing container is not realistic. Further, controlling of the pressure inside the processing container, especially, making an internal space of the processing container a high vacuum state is valid for reducing the purging process time, but facilities such as, for example, a pressure resistant container, a vacuum pump, a pressure control valve are needed. Accordingly, it is undesirable from the view point of simplifying the apparatus and reducing the cost. Further, increasing the flow rate of the purging gas is helpful in reducing the purging process time, but increases the amount of inert gas to be used such as N₂ leading to an increase of cost. Accordingly, a scheme has been in demand for maximizing a purging efficiency while suppressing the gas flow rate.

The present disclosure has been made in an effort to solve the problems discussed above, and intends to provide a microwave heat treatment apparatus and a processing method that are capable of reducing a purging process time while suppressing use amount of the purging gas using a simplified facility.

### SUMMARY

A microwave heat treatment apparatus according to one aspect of the present disclosure is provided. The microwave heat treatment apparatus includes a processing container which has a top wall, a bottom wall and side walls, and accommodates a target object to be processed, a microwave introducing device which generates microwaves for performing a heat treatment on the target object and introduces the microwaves into the processing container, a purging gas introducing unit which introduces a purging gas into the processing container, a support member which supports the target object in the processing container, a dielectric partition disposed between the support member and the purging gas introducing unit and provided with a plurality of gas holes transmitting the purging gas. In the microwave heat treatment apparatus, an internal space of the processing container is divided, by the dielectric partition and the processing container, into a first chamber in which at least the target object is accommodated and a second chamber into which the purging gas is directly introduced by the purging gas introducing unit, and is configured in such a manner that the purging gas introduced into the second chamber is diffused from the second chamber to the first chamber through the gas holes of the dielectric partition to purge atmosphere inside of the first chamber.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a cross sectional view illustrating a schematic configuration of a microwave heat treatment apparatus according to a first embodiment of the present disclosure.

FIG. 2 is a plan view of a partition in the first embodiment of the present disclosure.

FIG. 3A is an enlarged cross sectional view illustrating an example of gas holes of the partition in the first embodiment of the present disclosure.

FIG. 3B is an enlarged cross sectional view illustrating another example of gas holes of the partition in the first embodiment of the present disclosure.

FIG. 4 is an explanatory view of a schematic configuration of a high voltage power supply unit of a microwave introducing device in the first embodiment of the present disclosure.

FIG. 5 is a plan view illustrating a top surface of a ceiling portion of a processing container illustrated in FIG. 1.

FIG. 6 is an explanatory view illustrating a configuration of a control unit illustrated in FIG. 1.

FIG. 7 is a cross sectional view illustrating a schematic configuration of a microwave heat treatment apparatus according to a second embodiment of the present disclosure.

FIG. 8 is a cross sectional view illustrating a schematic configuration of a microwave heat treatment apparatus according to a third embodiment of the present disclosure.

FIG. 9 is a cross sectional view illustrating a schematic configuration of a microwave heat treatment apparatus according to a fourth embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The microwave heat treatment apparatus of the present disclosure includes a processing container which has a top wall, a bottom wall and side walls and accommodates a target object to be processed, a microwave introducing device which generate microwaves for performing a heat treatment on the target object and introduces the microwaves into the processing container, a purging gas introducing unit which introduces a purging gas into the processing container, a support member which supports the target object in the processing container, a dielectric partition disposed between the support member and the purging gas introducing unit and provided with a plurality of gas holes transmitting the purging gas.

In the microwave heat treatment apparatus of the present disclosure, an internal space of the processing container is divided, by the dielectric partition and the processing container, into a first chamber in which at least the target object is accommodated and a second chamber into which the purging gas is directly introduced by the purging gas introducing unit, and is configured in such a manner that the purging gas introduced into the second chamber is diffused from the second chamber to the first chamber through the gas holes of the dielectric partition to purge atmosphere inside of the first chamber.

The microwave heat treatment apparatus of the present disclosure may be configured in such a manner that C2 is larger than C1 on the assumption that a concentration of the purging gas of the first chamber is set to C1 and a concentration of the purging gas of the second chamber is set to C2 during introduction of the purging gas from the purging gas introducing unit.

In the microwave heat treatment apparatus of the present disclosure, the dielectric partition may be provided above the support member.

In the microwave heat treatment apparatus of the present disclosure, the dielectric partitions may be provided above and below the support member, respectively. In this case, the inner space of the processing container may be divided into a first chamber in which the target object is accommodated, an upper second chamber defined by a dielectric partition provided above the target object and the processing container and a lower second chamber defined by a dielectric partition provided below the target object and the processing container. Also, the purging gas introducing units which introduces the purging gas may be provided at the upper second chamber and the lower second chamber, respectively.

In the microwave heat treatment apparatus of the present disclosure, the dielectric partition is provided to surround the top, the bottom, the left and the right of the target object and, further, may include an opening portion. In this case, the opening portion may be formed to communicate with an opening formed in the processing container in order to carry the target object into and from the first chamber.

In the microwave heat treatment apparatus of the present disclosure, the gas holes provided at least at a region facing the target object in the dielectric partition.

The microwave heat treatment apparatus of the present disclosure may include a flow path which allows coolant to flow and provided within the dielectric partition.

In the microwave heat treatment apparatus of the present disclosure, the dielectric partition may be made of quartz.

In the microwave heat treatment apparatus of the present disclosure, the top wall of the processing container may include a plurality of microwave introducing ports which introduces microwaves generated in the microwave introducing device into the processing container.

The processing method of the present disclosure is a processing method in which a target object to be processed is heat-treated using the microwave heat treatment apparatus. In the processing method of the present disclosure, the microwave heat treatment apparatus a processing container which has a top wall, a bottom wall and side walls and accommodates the target object, a microwave introducing device which generate microwaves for performing a heat treatment on the target object and introduces the microwaves into the processing container, a purging gas introducing unit which introduces a purging gas into the processing container, a support member which supports the target object in the processing container, a dielectric partition disposed between the support member and the purging gas introducing unit and provided with a plurality of gas holes transmitting the purging gas. In the processing method of the present disclosure, an internal space of the processing container is divided, by the dielectric partition and the processing container, into a first chamber in which at least the target object is accommodated and a second chamber into which the purging gas is directly introduced by the purging gas introducing unit. Also, the processing method of the present disclosure includes a purging process of purging atmosphere inside of the first chamber by diffusing the purging gas into the first chamber through the gas holes of the dielectric partition, the purging gas being introduced into the second chamber by introducing the purging gas from the purging gas introducing unit into the second chamber; and an annealing process of heating the target object by introducing microwaves into the processing container by the microwave introducing device while diffusing the purging gas introduced into the second chamber into the first chamber through the gas holes of the dielectric partition, the purging gas being introduced from the purging gas introducing unit into the second chamber.

In the processing method of the present disclosure, C2 may be larger than C1 on the assumption that a concentration of the purging gas of the first chamber is set to C1 and a concentration of the purging gas of the second chamber is set to C2 in the purging process and the annealing process.

In the processing method of the present disclosure, the purging process may be performed each time when the target object is carried into/out of the processing container to sequentially process a plurality of the target objects.

According to the microwave heat treatment apparatus and the processing method of the present disclosure, it is possible to reduce a purging process time while suppressing use amount of purging gas using a simplified facility. Accordingly, throughput of a target objects to be processed, such as a substrate, processing according to the microwave heat treatment apparatus and the processing method of the present disclosure.

Hereinafter, exemplary embodiments of the present disclosure will be described in detail with reference to accompanying drawings.

### First Embodiment

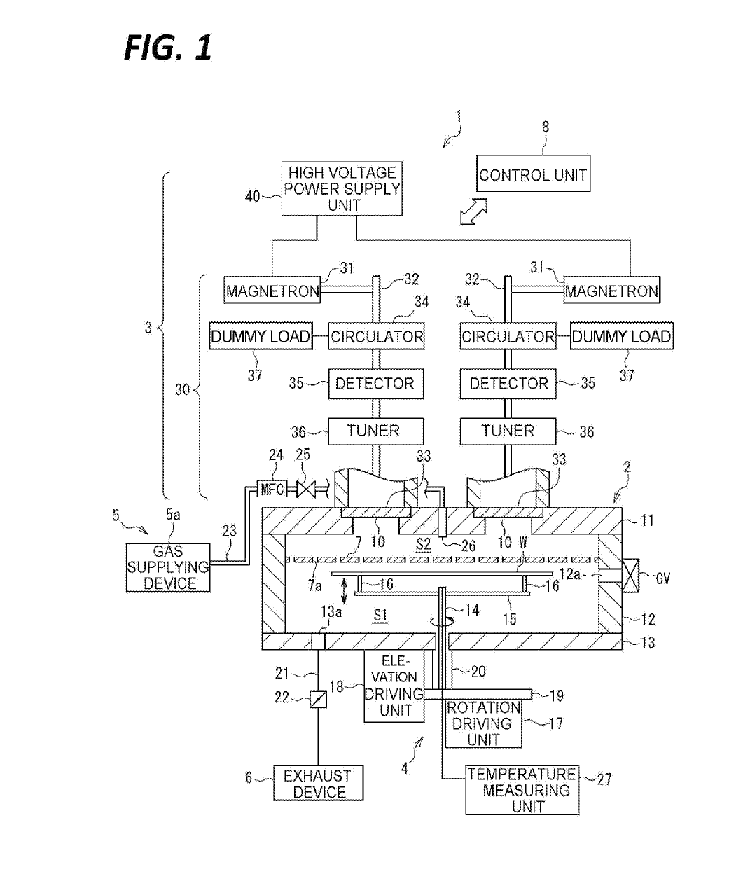

First, a microwave heat treatment apparatus according to a first embodiment of the present disclosure will be described with reference to FIG. 1. FIG. 1 is a cross sectional view illustrating a schematic configuration of a microwave heat treatment apparatus according to the present embodiment. The microwave heat treatment apparatus 1 according to the present embodiment is an apparatus which performs an annealing process by irradiating microwaves onto, for example, a semiconductor wafer (hereinafter, simply referred to as a “wafer”) for manufacturing a semiconductor device through a series of consecutive operations.

The microwave heat treatment apparatus 1 includes a processing container 2 which accommodates a wafer W, which is a target object to be processed, a microwave introducing device 3 which introduces microwaves into the processing container 2, a supporting device 4 which supports the wafer W in the processing container 2, a gas supply mechanism 5 which supplies gas into the processing container 2, an exhaust device 6 which depressurizes and exhausts inside the processing container 2, a partition 7 which divides an internal space of the processing container 2 into a plurality of regions, and a control unit 8 which controls the respective components of the microwave heat treatment apparatus 1.

<Processing Container>

The processing container 2 is made of a metal material, such as aluminum, aluminum alloy, or stainless steel.

The processing container 2 includes a plate-shaped ceiling portion 11 which serves as the top wall and a bottom portion 13 which serves as the bottom wall, a square-shaped side wall portion 12 which connects the ceiling portion 11 and the bottom portion 13, a plurality of microwave introducing ports 10 provided to vertically penetrate the ceiling portion 11, a carrying-in/carrying-out port 12a provided at the side wall portion 12 and an exhaust port 13a provided at the bottom portion 13. Further, the side wall portion 12 may be of a cylindrical shape. The carrying-in/carrying-out port 12a is used for carrying-in/carrying-out the wafer W between the processing container 2 and a transfer chamber (not illustrated) adjacent thereto. A gate valve GV is provided between the processing container 2 and the transfer chamber (not illustrated). The gate valve GV has a function of opening and closing the carrying-in/carrying-out port 12a and air-tightly seals the processing container 2 in a closed state and enables transfer of wafer W between the processing container 2 and the transfer chamber in an open state. Further, the gas introducing unit 26 for introducing gas into the processing container 2 is provided at the ceiling portion 11.

<Microwave Introducing Device>

The microwave introducing device 3 is provided above the processing container 2 and serves as a microwave introducing unit which introduces electromagnetic waves (microwaves) into the processing container 2. A configuration of the microwave introducing device 3 will be described in detail later.

<Supporting Device>

The supporting device 4 includes a tubular shaft 14 which penetrates substantially the center of the bottom portion 13 of the processing container 2 and extends to outside of the processing container 2, an arm portion 15 provided substantially in the horizontal direction in the vicinity of an upper end of the shaft 14, and a plurality of supporting pins 16 serving as a support member detachably mounted on the arm portion 15. Further, the supporting device 4 includes a rotation driving unit 17 rotating the shaft 14, an elevation driving unit 18 vertically shifting the shaft 14 and a movable connecting unit 19 supporting the shaft 14 and connecting the rotation driving unit 17 and the elevation driving unit 18. The rotation driving unit 17, the elevation driving unit 18 and the movable connecting unit 19 are provided outside of the processing container 2. Further, in a case of intending to make inside of the processing container 2 a vacuum state, a sealing mechanism 20 such as bellows may be provided around a portion where the shaft 14 penetrates the bottom portion 13.

The plurality of (three in the present embodiment) supporting pins 16 contact and support a rear surface of the wafer W in the processing container 2. The plurality of supporting pins 16 are disposed in such a manner that the upper end portions thereof are arranged in a circumferential direction of the wafer W. Each supporting pin 16 is detachably mounted on the arm portion 15. The plurality of supporting pins 16 and the arm portion 15 are made of a dielectric material, such as quartz or ceramics. Further, the number of supporting pins 16 is not limited three, as long as the wafer W can be stably supported by the supporting pins 16.

In the supporting device 4, the shaft 14, the arm portion 15, the rotation driving unit 17 and the movable connecting unit 19 constitute a rotation mechanism which rotates the wafer W supported by the supporting pin 16 in a horizontal direction. The rotation driving unit 17 is driven to rotate the plurality of supporting pins 16 and the arm portion 15 centering around the shaft 14 and cause each supporting pin 16 to perform a circular motion (revolution). Further, the shaft 14, the arm portion 15, the elevation driving unit 18 and the movable connecting unit 19 constitute a height position adjustment mechanism which adjusts a height position of the wafer W supported by supporting pin 16 in the supporting device 4. The plurality of supporting pins 16 and the arm portions 15 are configured such that they are moved up and down to be vertically shifted along with the shaft 14 by driving the elevation driving unit 18. Further, in the microwave heat treatment apparatus 1, the rotation driving unit 17, the elevation driving unit 18 and the movable connecting unit 19 are arbitrary components and may not be provided.

The rotation driving unit 17 is not particularly limited as long as it is able to rotate the shaft 14, and may be provided with, for example, a motor which is not illustrated. The elevation driving unit 18 is not particularly limited as long as it is able to move up and down the shaft 14 to be vertically shifted, and may be provided with, for example, a ball screw. The rotation driving unit 17 and the elevation driving unit 18 may be an integrally formed mechanism or may have a configuration without having the movable connecting unit 19. Further, a rotation mechanism which rotates the wafer W in the horizontal direction and the height position adjustment mechanism which adjusts the height position of the wafer W may have another configuration as long as they may implement the horizontal rotation and the height position adjustment.

<Exhaust Device>

The exhaust device 6 is provided with a vacuum pump, for example, a dry pump. The microwave heat treatment apparatus 1 also includes an exhaust pipe 21 which connects the exhaust port 13a and the exhaust device 6, and a pressure control valve 22 provided on the way of the exhaust pipe 21. The vacuum pump of the exhaust device 6 is operated to depressurize and exhaust the internal space of the processing container 2. Further, the microwave heat treatment apparatus 1 is able to perform a process under the atmospheric pressure and in such a case, the vacuum pump is unnecessary. Further, an exhaust equipment provided in a facility at which the microwave heat treatment apparatus 1 is provided may be used instead of using the vacuum pump such as the dry pump as the exhaust device 6. In the microwave heat treatment apparatus 1, when the purging process of purging the internal space of the processing container 2 is performed, it is desirable that an exhaustion is performed to the extent that the amount of purging gas supplied into the processing container 2 is balanced with the amount of gas to be exhausted to maintain the internal space of the processing container 2 at a constant pressure using, for example, the exhaust equipment of the facility.

<Gas Supply Mechanism>

The microwave heat treatment apparatus 1 also includes the gas supply mechanism 5 which supplies gas into the processing container 2. The gas supply mechanism 5 includes a gas supplying device 5a including one or a plurality of gas supply sources, and one or plurality of pipes 23a (only one piping is illustrated) connected to the gas supplying device 5a and introducing the processing gas into the processing container 2. The gas supply mechanism 5 also includes a mass flow controller (MFC) 24 provided on the way of the piping 23a and one or a plurality of opening/closing valves (only one valve is illustrated). The flow rate of gas to be supplied into the processing container 2 is controlled by the mass flow controller 24 and the opening/closing valve. The piping 23 is connected to the gas introducing unit 26 provided at the ceiling portion 11 of the processing container 2.

The gas supplying device 5a supplies, for example, the purging gas for substituting atmosphere within the processing container 2 through the piping 23a and the gas introducing unit 26. An inert gas, for example, N2 may be used as the purging gas. Further, the gas supply mechanism 5 may be configured in such a manner that gas, for example, Ar, He, Ne, O₂, H₂ may be supplied into the processing container 2 as a processing gas or a cooling gas in addition to the purging gas. Further, gas introduction into the processing container 2 may be performed by using, for example, a shower head method in which gas are introduced from a plurality of gas injection ports or a side flow method in which gas are introduced from the side wall portion 12. Further, an external gas supplying devices which is not included in the configuration of the microwave heat treatment apparatus 1 may be used instead of the gas supplying device 5a.

<Partition>

The partition 7 is provided above the wafer W supported by the supporting pin 16 as the support member to be faced with the wafer W. The partition 7 includes a plurality of gas holes 7a which transmit the purging gas. The partition 7 is fixed to the side wall portion 12 of the processing container 2. The partition 7 is made of a dielectric material having a property of blocking gas and transmitting microwaves. In the present embodiment, it is more desirable that material (material for which dielectric constant (∈r)×dielectric loss tangent (tan δ) is smaller than 0.005), such as quartz or a synthetic resin having dielectric constant and dielectric loss tangent which are substantially the same as those of quartz having a high transmissivity of microwaves of, for example, 2.45 GHz or 5.8 GHz. As such, the dielectric material having a high transmissivity is used in accordance with a frequency of microwaves to be used, so that it becomes equal to a state in which the partition does not exist in propagation or diffusion of microwaves and it does not become obstacle of heating the wafer W by microwaves.

The internal space of the processing container 2 is partitioned into, by the partition 7 and the processing container 2, at least a first chamber S1 in which the wafer W is accommodated and a second chamber S2 into which the purging gas is directly introduced by the gas introducing unit 26. As such, the internal space of the processing container 2 is divided into two by the partition 7. The carrying-in/carrying-out port 12a is provided at a portion, which faces the first chamber S1, of the side wall portion 12. That is, the first chamber S1 is configured to be able to communicate with outside of the processing container 2 through the carrying-in/carrying-out port 12a in a state where the gate valve GV is open. Further, the first chamber S1 is connected to an opening (e.g., exhaust port 13a) for exhausting gas of the processing container 2 connected to the exhaust device 6 or the exhaust equipment of the facility.

The gas introducing unit 26 is provided at a portion, which faces the second chamber S2, in the ceiling portion 11 as described above and thus, the purging gas is introduced into the second chamber S2. The purging gas introduced from the gas introducing unit 26 into the second chamber S2 is diffused from the second chamber S2 to the first chamber S1 through a plurality of gas holes 7a of the partition 7. By doing this, atmosphere of the first chamber S1 may be substituted. Further, a size, a flow path resistance, the number, an opening ratio and a disposition of the plurality of gas holes 7a in the partition 7 are specified such that C2 is larger than C1 on the assumption that a concentration of the purging gas in the first chamber S1 is set to C1 and a concentration of the purging gas in the second chamber S2 is set to C2 during introduction of the purging gas from the gas introducing unit 26.

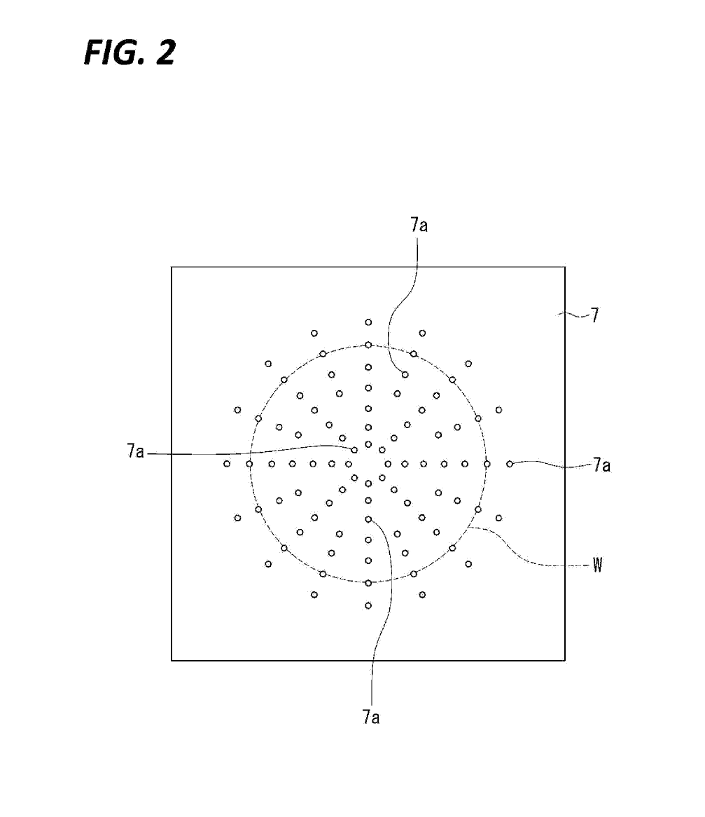

The gas holes 7a are desirably provided at least at a region facing the wafer W in the partition 7 in order to easily purge atmosphere on the surface and in the vicinity of the wafer W. Specifically, the plurality of gas holes 7a are desirably formed to be distributed in an area larger than or equal to an area of the wafer W. FIG. 2 is a plan view of the partition 7 illustrating an example of disposition of the gas holes 7a. A position of the wafer W facing the partition 7 is illustrated in a broken line. In the example illustrated in FIG. 2, when viewed from above, a plurality of circular gas holes 7a are radially or concentrically disposed in a region larger than or equal to the area of the wafer W from the center of the partition 7 (in line with the center of the wafer W in the present embodiment).

The gas holes 7a are openings that penetrate the partition 7. The gas holes 7a may be formed to have a diameter of, for example, 1 mm or less, preferably within a range from 0.5 mm or more to 1 mm or less in consideration of the flow path resistance at the time of transmitting the purging gas such that a relationship of C2>C1 may be maintained. Further, the shape or disposition of the gas holes 7a is not limited to that illustrated in FIG. 2. The shape of gas holes 7a may be, for example, an ellipsis and a quadrangle in addition to a circle, and the arrangement of the gas holes 7a may be, for example, a latticed shape or a helical shape. Further, the size (diameter) or shape of the gas holes 7a may be changed by the region in the partition 7. Further, the number of the gas holes 7a in the partition 7 is not particularly limited. The opening ratio by the plurality of gas holes 7a is desirably set to a range within, for example, 1×10⁻² to 1×10⁻⁴. Here, the opening ratio means that a ratio of a total of the opening areas occupied by the plurality of gas holes 7a to the area of the partition 7 and the “area of the partition 7” indicates any one area of a plane located above and another plane located below the partition 7 on the assumption that the gas holes 7a do not exist in the upper and lower planes. The opening ratio is set to be fallen within the range and thus, it becomes possible to efficiently diffuse the purging gas from the second chamber S2 side into which the purging gas is directly introduced toward the first chamber S1 side in which the wafer W is accommodated while maintaining a relationship of C2>C1.

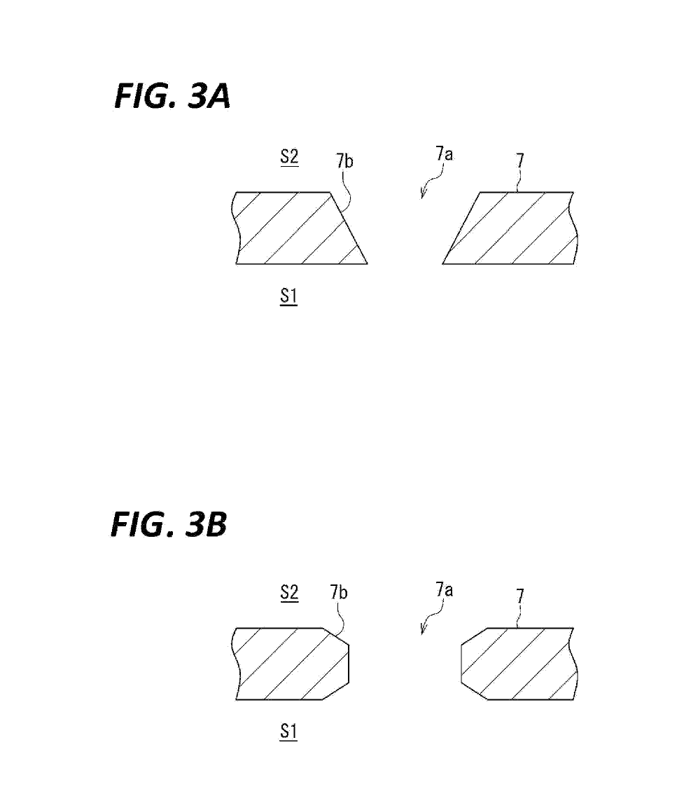

Further, a diaphragm structure may be provided in the gas holes 7a as a desirable aspect. FIG. 3A and FIG. 3B illustrate an example of configuration of the gas holes 7a having a diaphragm structure. In FIG. 3A, the gas holes 7a are formed in such manner that the diameter of the opening becomes narrower from the second chamber S2 side into which the purging gas is directly introduced by the gas introducing unit 26 toward the first chamber S1 side in which the wafer W is accommodated. That is, the inclined wall surface 7b of the gas holes 7a formed of a tapered shape is formed of a diaphragm portion, and is formed in such a manner that the flow path resistance is increased from the second chamber S2 side toward an outlet of the first chamber S1 side. Further, in FIG. 3B, the gas holes 7a are formed in such a manner that the diameter of the opening becomes narrower from the respective second chamber S2 side and first chamber S1 side toward the central portion of a thickness direction of the partition 7. In this case, the inclined wall surface 7b of the gas holes 7a formed of a tapered shape is also formed of the diaphragm portion. The shape is formed to have such a diaphragm structure to adjust the flow path resistance of the gas holes 7a and thus, it becomes easy to maintain the relationship of C2>C1. Further, by the diaphragm structure, the flow rate of the purging gas at the time of transmitting the gas holes 7a is increased to prevent oxygen gas among atmosphere from entering from the first chamber S1 side toward the second chamber S2 side, thereby enhancing the operation of the partition 7. Further, the diaphragm structure of the gas holes 7a is not limited to the shape illustrated in FIG. 3A and FIG. 3B.

<Temperature Measuring Unit>

The microwave heat treatment apparatus 1 also includes a plurality of radiation thermometers (not illustrated) measuring a surface temperature of the wafer W and a temperature measuring unit 27 connected to the radiation thermometers.

<Microwave Introducing Device>

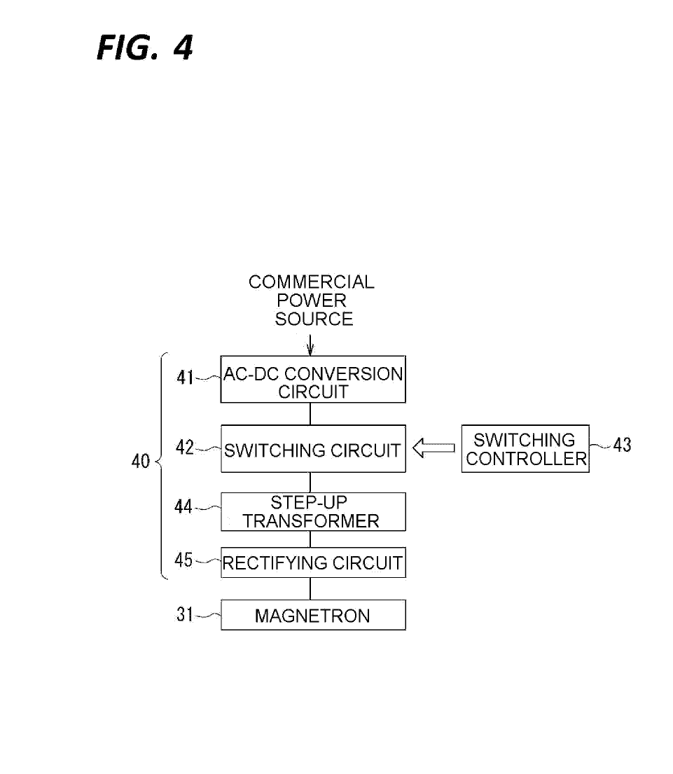

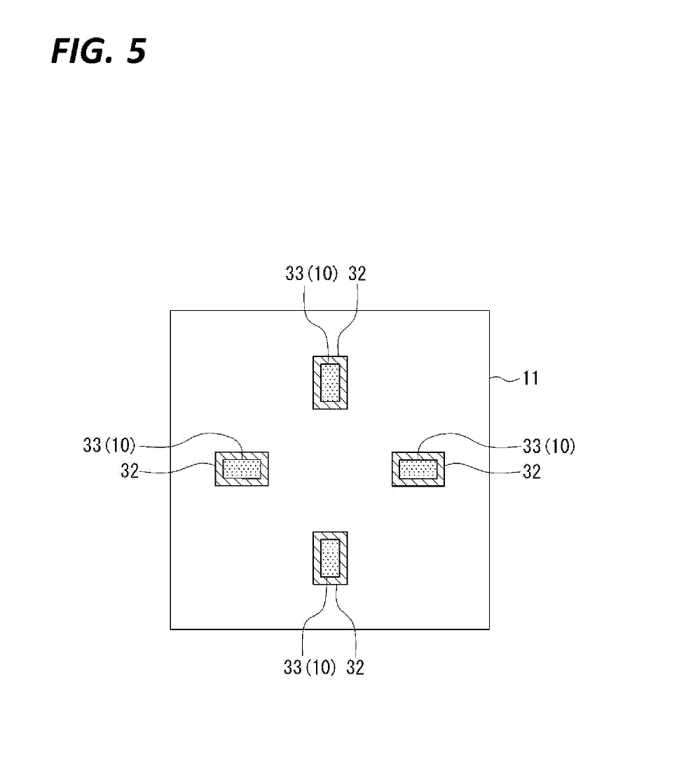

Next, a configuration of the microwave introducing device 3 will be described with reference to FIG. 1, FIG. 4 and FIG. 5. FIG. 4 is an explanatory view illustrating a schematic configuration of a high voltage power supply unit of the microwave introducing device 3. FIG. 5 is a plan view illustrating a top surface of the ceiling portion 11 of the processing container 2 illustrated in FIG. 1.

As described above, the microwave introducing device 3 is provide above the processing container 2 and serves as a microwave introducing unit which introduces electromagnetic waves (microwaves) into the processing container 2. As illustrated in FIG. 1, the microwave introducing device 3 includes a plurality of microwave units 30 which introduce microwaves into the processing container 2 and a high voltage power supply unit 40 connected to the plurality of microwave units 30.

(Microwave Unit)

In the present embodiment, configurations of the plurality of microwave unit 30 are the same with each other. Each microwave unit 30 includes a magnetron 31 which generates microwaves for processing the wafer W, a waveguide 32 which transfers microwaves generated in the magnetron 31 to the processing container 2, and a transmission window 33 fixed to the ceiling portion 11 in order to block the microwave introducing port 10. The magnetron 31 corresponds to a microwave source in the present disclosure.

As illustrated in FIG. 5, the processing container 2 includes four microwave introducing ports 10 disposed at regular intervals in the circumferential direction to form substantially the cross shape as a whole in the ceiling portion 11 in the present embodiment. Each microwave introducing port 10 forms a rectangle when viewed from a plane having long sides and short sides. A size or a ratio of the long side and the short side of each microwave introducing port 10 may be different for each microwave introducing port 10, but the four microwave introducing ports 10 desirably have the same size and shape from a view point of increasing uniformity of the annealing process for the wafer W and improving controllability. Further, each microwave unit 30 is connected to each microwave introducing port 10 in the present embodiment. That is, the number of the microwave units 30 is four.

The magnetron 31 has an anode and a cathode (illustration thereof are omitted) to which a high voltage supplied by the high voltage power supply unit 40 is applied. Further, a device capable of oscillating microwave having various frequencies may be used as the magnetron 31. Microwaves generated by the magnetron 31 are selected to have an optimum frequency for each target object and for example, in the annealing process, microwaves having a high frequency of, such as 2.45 GHz or 5.8 GHz, is desirable, and most desirably microwaves having a frequency of 5.8 GHz.

The waveguide 32 has a shape of which cross section is a rectangle or a squared-cylindrical shape, and extends upward from a top surface of the ceiling portion 11 of the processing container 2. The magnetron 31 is connected to the vicinity of the upper end of the waveguide 32. The lower end of the waveguide 32 is abutted to the top surface of the transmission window 33. Microwaves generated in the magnetron 31 are introduced into the processing container 2 through the waveguide 32 and the transmission window 33.

The transmission window 33 is made of the dielectric material, for example, quartz or ceramics. A portion between the transmission window 33 and the ceiling portion 11 is air-tightly sealed with a sealing member (not illustrated). A distance (gap) from a bottom surface of the transmission window 33 to a surface of the wafer W supported by supporting pin 16 is desirably set to, for example, 25 mm or more and more desirably set to be adjusted variably within a range from 25 mm to 50 mm, from a viewpoint of suppressing microwaves from being directly radiated to the wafer W.

The microwave unit 30 also includes a circulator 34, a detector 35 and a tuner 36 provided on the way of the waveguide 32, and a dummy load 37 connected to the circulator 34. The circulator 34, the detector 35 and the tuner 36 are provided in this order from the upper end side of the waveguide 32. The circulator 34 and the dummy load 37 constitute an isolator which isolates reflected waves from the processing container 2. That is, the circulator 34 induces the reflected waves from the processing container 2 to the dummy load 37 and the dummy load 37 converts the reflected waves induced by the circulator 34 into heat.

The detector 35 serves to detect the reflected waves from the processing container 2 in the waveguide 32. The detector 35 is configured by, for example, an impedance monitor, specifically, a standing wave monitor which detects electric field of the standing waves in the waveguide 32. The standing wave monitor may be configured by, for example, three pins protruding into the internal space of the waveguide 32. A place, phase and strength of the electric field of the standing waves by the standing wave monitor may be detected to detect the reflected waves from the processing container 2. Further, the detector 35 may be configured by a directional coupler capable of detecting the travelling waves and reflected waves.

The tuner 36 has a function of matching impedance between the magnetron 31 and the processing container 2. The impedance matching by the tuner 36 is performed based on a detection result of the reflected waves in the detector 35. The tuner 36 may be configured by a conductor plate (illustration thereof is omitted) provided to be loaded and unloaded into and from, for example, the internal space of the waveguide 32. In this case, an amount of protrusion into the internal space of the waveguide 32 of the conductor plate may be controlled to adjust an amount of electrical power of the reflected waves to adjust impedance between the magnetron 31 and the processing container 2.

(High Voltage Power Supply Unit)

The high voltage power supply unit 40 supplies a high voltage for generating microwaves to the magnetron 31. As illustrated in FIG. 4, the high voltage power supply unit 40 includes an AC-DC conversion circuit 41 connected to a commercial power source, a switching circuit 42 connected to the AC-DC conversion circuit 41, a switching controller 43 controlling an operation of the switching circuit 42, a step-up transformer 44 connected to the switching circuit 42, and a rectifying circuit 45 connected to the step-up transformer 44. The magnetron 31 is connected to the step-up transformer 44 through the rectifying circuit 45.

The AC-DC conversion circuit 41a circuit which rectifies AC from the commercial power source (e.g., AC three phase 200 V) to convert the AC into DC having a predetermined waveform. The switching circuit 42 is a circuit which controls ON/OFF of the DC converted by the AC-DC conversion circuit 41. In the switching circuit 42, a phase shift type PWM (Pulse Width Modulation) control or a PAM (Pulse Amplitude Modulation) control is performed by the switching controller 43 and thus, a pulse type voltage waveform is generated. The step-up transformer 44 steps-up the voltage waveform output from the switching circuit 42 to a voltage waveform having a predetermined magnitude. The rectifying circuit 45 is a circuit which rectifies voltage which is stepped-up by the step-up transformer 44 and supplies the voltage to the magnetron 31.

<Control Unit>

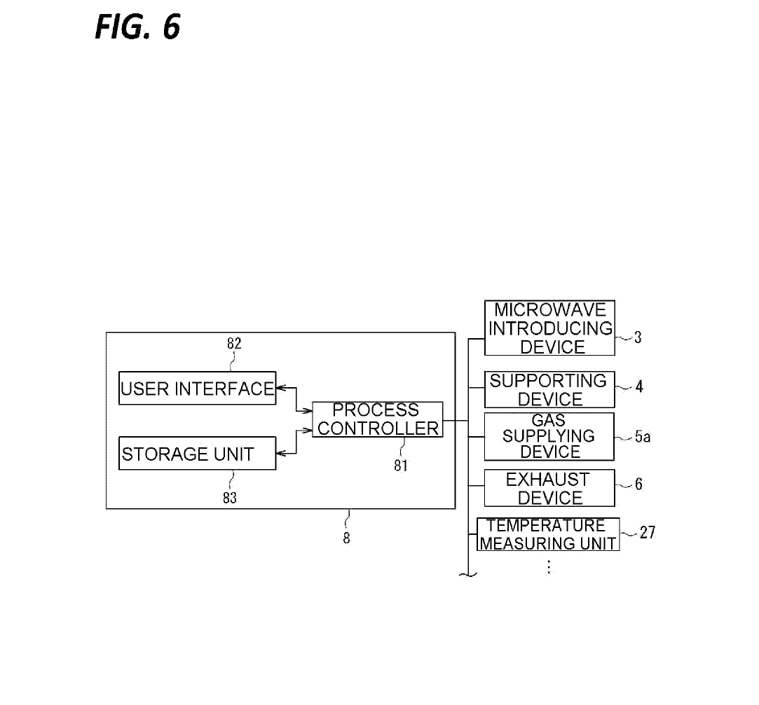

The respective components of the microwave heat treatment apparatus 1 are connected to the control unit 8 and controlled by the control unit 8. The control unit 8 is typically a computer. FIG. 6 is an explanatory view illustrating a configuration of the control unit 8 illustrated in FIG. 1. In the example illustrated in FIG. 6, the control unit 8 includes a process controller 81 provided with a CPU and a user interface 82 and a storage unit 83 that are connected to the process controller 81.

The process controller 81 is a control unit which comprehensively controls the respective components (e.g., the microwave introducing device 3, the supporting device 4, the gas supplying device 5a, the exhaust device 6, the temperature measuring unit 27) relevant to process conditions, such as for example, a temperature, a pressure, a flow rate of gas, a microwave output, a rotation speed of the wafer W, in the microwave heat treatment apparatus 1.

The user interface 82 includes, for example such as, a keyboard or a touch panel, which is used for, such as an input manipulation of commands performed by a process manager, or a display which visually displays operation state of the microwave heat treatment apparatus 1.

A recipe in which process condition data is recorded or a control program (software) to implement various processes performed in the microwave heat treatment apparatus 1 by control of the process controller 81 is stored in the storage unit 83. The process controller 81 calls any control program or recipe from the storage unit 83 according to, such as instruction from the user interface 82, as necessary. By doing this, a desired processing is performed within the processing container 2 of the microwave heat treatment apparatus 1 under the control of the process controller 81.

The control program and recipe stored in a computer readable medium, for example, a CD-ROM, a hard disk, a flexible disk, a flash memory, a DVD, a Blu-ray disk may be used. Further, the recipe may be used online by being transmitted frequently from another device through, for example, a dedicated line, as necessary.

The microwave heat treatment apparatus 1 of the present embodiment may be desirably used in an annealing process for activating doping atoms injected into a diffusion layer in the manufacturing process of a semiconductor device.

[Processing Sequence]

Next, a processing sequence when the annealing process is performed on the wafer W in the microwave heat treatment apparatus 1 will be described.

First, an instruction to perform the annealing process in the microwave heat treatment apparatus 1 is input, for example, from the user interface 82 to the process controller 81. Next, the process controller 81 receives the instruction and reads the recipe stored in the storage unit 83 or a computer readable storage medium. Next, a control signal is transmitted from the process controller 81 to the respective end devices (e.g., the microwave introducing device 3, the supporting device 4, the gas supplying device 5a, the exhaust device 6) of the microwave heat treatment apparatus 1, such that the annealing process is performed according to conditions based on the recipe.

Next, the gate valve GV becomes an open state and thus, the wafer W is carried into the processing container 2 by passing through the gate valve GV and the carrying-in/carrying-out port 12a and displaced on the plurality of supporting pins 16 by a transfer device (not illustrated). The plurality of supporting pins 16 drive the elevation driving unit 18 and thus, the wafer W is moved up and down vertically together with the shaft 14 and the arm portion 15 and set at a predetermined height.

The gate valve GV is open and external atmosphere enters into the processing container 2 during carrying-in operation of the wafer W and thus, the purging gas is consecutively introduced from the gas supplying device 5a through the gas introducing unit 26 into the second chamber S2. The purging gas is continuously introduced to maintain the relationship of C2>C1 and prevent the external atmosphere containing oxygen from being entered into the second chamber S2. The purging gas introduced into the second chamber S2 is gradually diffused into the first chamber S1 due to a pressure difference and a concentration gradient of the purging gas between the second chamber S2 and the first chamber S1.

Next, the gate valve GV is closed and, the purging process is performed with introducing the purging gas from the gas supplying device 5a through the gas introducing unit 26 into the processing container 2 while depressurizing and exhausting inside of the processing container 2 by the exhaust device 6 when necessary. The internal space of the processing container 2 is adjusted to a predetermined pressure by adjusting an exhaust amount and a gas supply amount. Further, the concentration C2 of the purging gas of the second chamber S2 is higher than the concentration C1 of the purging gas of the first chamber S1 and thus, a target to be subjected to the purging process is mainly the first chamber S1. Therefore, a space volume to be purged is smaller as compared with the entire volume of the processing container 2 and thus, a time required for the purging process may be reduced.

Next, voltage is applied from the high voltage power supply unit 40 to the magnetron 31 to generate microwaves. Microwaves generated in the magnetron 31 propagate the waveguide 32 and transmit the transmission window 33, and the microwaves are introduced into a space above the wafer W in the processing container 2. In the present embodiment, microwaves are sequentially generated in the plurality of the magnetrons 31 and microwaves are alternately introduced into the processing container 2 from each microwave introducing port 10. Further, a plurality of microwaves may be simultaneously generated in the plurality of the magnetrons 31 and simultaneously introduced into the processing container 2 from each microwave introducing port 10.

Microwaves introduced into the processing container 2 are irradiated on the wafer W and thus, the wafer W is rapidly heated by electromagnetic heating such as joule heating, magnetic heating, induction heating. As a result, the annealing process is performed on the wafer W. Further, the wafer W may be rotated in a horizontal direction or a height position of the wafer W may be changed by the supporting device 4 during the annealing process. Partiality of microwaves irradiated onto the wafer W may be made smaller by rotating the wafer W in a horizontal direction or changing the height position of the wafer W during the annealing process, such that a heating temperature within the plane of the wafer W may be uniformized

During the annealing process, a small amount of the purging gas is consecutively introduced from the gas introducing unit 26 into the second chamber S2 to maintain the relationship of C2>C1 and prevent external atmosphere from entering into the second chamber S2. The purging gas introduced into the second chamber S2 is gradually diffused into the first chamber S1 due to a pressure difference and a concentration gradient of the purging gas between the second chamber S2 and the first chamber S1 and is also gradually discharged from the exhaust port 13a. By doing this, substitution of atmosphere within the first chamber S1 is consecutively and slowly progressed during the annealing process.

When the control signal for completing the annealing process is transmitted from the process controller 81 to the respective end devices of the microwave heat treatment apparatus 1, generation of the microwaves is stopped and the annealing process onto the wafer W is ended. Next, the gate valve GV is open and a height position of the wafer W on the supporting pin 16 is adjusted and then the wafer W is carried-out by a transfer device (not illustrated).

The gate valve GV is open and external atmosphere is entering into the processing container 2 during the carrying-out operation and thus, a small amount of the purging gas is continuously introduced from the gas introducing unit 26 into the second chamber S2 to maintain the relationship of C2>C1 and prevent the external atmosphere containing oxygen from entering into the second chamber S2. The purging gas introduced into the second chamber S2 is gradually diffused into the first chamber S1 due to a pressure difference and a concentration gradient of the purging gas between the second chamber S2 and the first chamber S1.

By repeating operations described above, the annealing process may be performed to the plurality sheets of the wafer W while replacing the wafer W in the microwave heat treatment apparatus 1.

<Function>

Next, functional effects of the microwave heat treatment apparatus 1 according to the present embodiment will be described. The processing container 2 of the microwave heat treatment apparatus 1 includes a carrying-in/carrying-out port 12a provided at the side wall portion 12 for carrying-in or carrying-out the wafer W. Therefore, external atmosphere, for example, oxygen is mixed into the processing container 2 each time when the wafer W is carried-in and/or carried-out. A metal film, for example, on a surface of the wafer W may be oxidized when the wafer W is annealed in a state where oxygen is mixed within the processing container 2. As a scheme for expelling external atmosphere, such as oxygen mixed into the processing container 2 in a short time, a method may be considered in which the purging process is performed by making the internal space of the processing container 2 a high vacuum state of a predetermined pressure, for example, about 10 Pa to 1×10⁴ Pa, or a method may be considered in which the purging process is performed by introducing the purging gas having a large flow rate of, for example, about 10,000 mL/min to 200,000 mL/min (sccm) into the processing container 2. However, making the internal space of the processing container 2 a high vacuum state needs a facility such as a pressure resistance container, or a vacuum pump, a pressure control valve and thus, the methods are not desirable from the viewpoint of making an apparatus simple and/or making cost low. Further, increase of the flow rate of the purging gas leads to an increase of cost.

Accordingly, the microwave heat treatment apparatus 1 of the present embodiment divides the internal space of the processing container 2, by the partition 7 and the processing container 2, into at least the first chamber S1 in which the wafer W is accommodated and the second chamber S2 into which the purging gas is directly introduced by the gas introducing unit 26 in order to efficiently exhaust oxygen within the processing container 2, irrespective of the methods described above. The external atmosphere introduced at the time of carrying-in and/or carrying-out of the wafer W is prevented from entering into the second chamber S2 due to existence of the partition 7, and most of the external atmosphere stays in the first chamber S1. Also, the purging gas is introduced from the gas introducing unit 26 to the second chamber S2 in the microwave heat treatment apparatus 1 and thus, the purging gas is diffused from the second chamber S2 into the first chamber S1 through a plurality of gas holes 7a of the partition 7 to purge the atmosphere of the first chamber S1. In this case, a volume substantially required to be subjected to substitution of atmosphere is substantially the same as the volume of the first chamber S1. Therefore, the purging process may be completed in a short period of time as compared to a case of purging the entirety of the internal space of the processing container 2. Further, a total flow rate of the purging gas required for the purging process may be largely reduced as compared to a case of purging the entirety of the internal space of the processing container. Furthermore, it becomes possible to implement an efficient purging process and thus, it does not need to make the internal space of the processing container 2 a high-vacuum state. Accordingly, minimum vacuum facility is enough for the microwave heat treatment apparatus 1.

Further, a small amount of the purging gas may be consecutively introduced from the gas introducing unit 26 into the second chamber S2 all the time, for example, during the carrying-in/carrying-out operation of the wafer W or during performing the annealing process on the wafer W without being limited to the purging process during which the purging gas is introduced from the gas introducing unit 26 at a predetermined flow rate. The relationship of C2>C1 may be maintained, on the assumption that the concentration of the purging gas in the first chamber S1 is set to C1 and the concentration of the purging gas in the second chamber S2 is set to C2, by consecutively introducing a small amount of the purging gas into the second chamber S2. By doing this, oxygen mixed into the processing container 2 from outside of the processing container 2 is prevented from being diffused from the first chamber S1 into the second chamber S2 through the gas holes 7a.

As described above, the use amount of the purging gas may be suppressed with simple facilities, and the time required for the purging process may be reduced in the microwave heat treatment apparatus 1 and the processing method of the present embodiment. Accordingly, throughput of the wafer W processing may be improved by using the microwave heat treatment apparatus 1.

### Second Embodiment

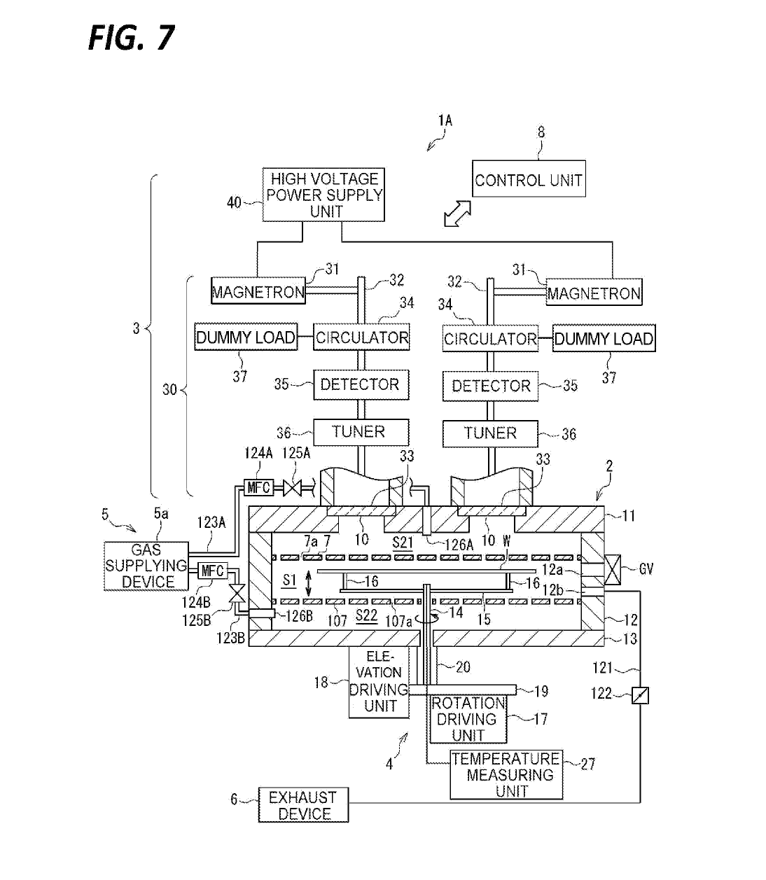

Next, a microwave heat treatment apparatus according to a second embodiment of the present disclosure will be described with reference to FIG. 7. FIG. 7 is a cross sectional view illustrating a schematic configuration of a microwave heat treatment apparatus 1A according to the present embodiment. The microwave heat treatment apparatus 1A according to the present embodiment is an apparatus which performs an annealing process by irradiating microwaves onto, for example, a wafer W for manufacturing a semiconductor device through a series of consecutive operations. In the following description, mainly the difference between microwave heat treatment apparatus 1A and the microwave heat treatment apparatus 1 of the first embodiment will be described. In FIG. 7, like reference numerals are given to the same components as those of the microwave heat treatment apparatus 1 of the first embodiment, and descriptions thereof will be omitted.

The microwave heat treatment apparatus 1A of the present embodiment includes the dielectric partitions above and below the wafer W which is being supported by the supporting pin 16, respectively. That is, the microwave heat treatment apparatus 1A includes a partition 7 above the supporting pin 16 and includes a partition 107 below the supporting pin 16. The partition 7 has the same configuration as the partition 7 in the first embodiment and includes a plurality of gas holes 7a. Further, the partition 107 also has the same configuration as the partition 7 in the first embodiment and includes a plurality of gas holes 107a.

The processing container 2 of the microwave heat treatment apparatus 1A of the present embodiment includes therein a first chamber S1 in which the wafer W is accommodated, an upper second chamber S21 provided above the first chamber S1 and a lower second chamber S22 provided above the first chamber S1.

The first chamber S1 is defined by the partition 7, the partition 107 and the side wall portion 12 of the processing container 2. The carrying-in/carrying-out port 12a is provided at a portion, which faces the first chamber S1, of the side wall portion 12 and the first chamber S1 is formed to be communicated with outside of the processing container 2 through the carrying-in/carrying-out port 12a in a state where the gate valve GV is open. The upper second chamber S21 is defined by the partition 7, the ceiling portion 11 and the side wall portions 12 of the processing container 2. The lower second chamber S22 is defined by the partition 7, the bottom portion 13 and the side wall portion 12 of the processing container 2. As such, the internal space of the processing container 2 is divided into three, by a pair of the upper and the lower partitions 7 and 107.

In the microwave heat treatment apparatus 1A of the present embodiment, the gas supply mechanism 5 includes a gas supplying device 5a including one or a plurality of gas supply sources and a plurality of pipes 123A and 123B each of which is connected to the gas supplying device 5a, and introduces the processing gas into the processing container 2. Further, the gas supply mechanism 5 includes a mass flow controller MFC 124A and one or a plurality of opening/closing valves 125A (only one opening/closing valve is illustrated) that are provided on the way of the piping 123A. A flow rate of gas supplied into the upper second chamber S21 above the processing container 2, for example, is controlled by the mass flow controller 124A and the opening/closing valve 125A. Further, the gas supply mechanism 5 includes a mass flow controller MFC 124B and one or a plurality of opening/closing valves 125B (only one opening/closing valve is illustrated) provided on the way of the piping 123B. A flow rate of gas supplied into the lower second chamber S22 below the processing container 2, for example, is controlled by the mass flow controller 124B and the opening/closing valve 125B.

In the microwave heat treatment apparatus 1A of the present embodiment, the gas introducing unit 126A is provided at a portion, which faces the upper second chamber S21, in the ceiling portion 11. The purging gas is directly introduced from the gas introducing unit 126A to the upper second chamber S21. The gas introducing unit 126A is connected to the gas supplying device 5a through the piping 123A. The gas supplying device 5a supplies the purging gas, for example, for substituting atmosphere, into the processing container 2 through the piping 123A and the gas introducing unit 126A.

Further, in the microwave heat treatment apparatus 1A of the present embodiment, the gas introducing unit 126B is provided at a portion which faces the lower second chamber S21, in the side wall portion 12. The gas introducing unit 126B is connected to the gas supplying device 5a through the piping 123B. The gas supplying device 5a supplies the purging gas, for example, for substituting atmosphere, into the processing container 2 through the piping 123B and the gas introducing unit 126B.

Further, in the microwave heat treatment apparatus 1A of the present embodiment, the exhaust port 12b is provided at a portion which faces the first chamber S1, in the side wall portion 12. The exhaust port 12b is provided at a portion which is at an opposite side to the side wall portion 12 at which the gas introducing unit 126B is provided. The microwave heat treatment apparatus 1A further includes an exhaust pipe 121 which connects the exhaust port 12b and the exhaust device 6 and a pressure control valve 122 provided on the way of the exhaust pipe 121. The atmosphere inside the first chamber S1 may be discharged to outside of the processing container 2 through the exhaust port 12b without passing through the upper second chamber S21 or the lower second chamber S22.

The purging gas is directly introduced from the gas introducing unit 126A into the upper second chamber S21. The purging gas introduced into the upper second chamber S21 is diffused from the upper second chamber S21 into the first chamber S1 through the plurality of gas holes 7a of the partition 7 to purge atmosphere inside the first chamber S1. The exhaustion from the first chamber S1 is performed through the exhaust port 12b. Further, gas introduction into the upper second chamber S21 may be performed by using, for example, a shower head method in which gas are introduced from a plurality of gas injection ports or a side flow method in which gas are introduced from the side wall portion 12. Further, an external gas supplying devices which is not included in the configuration of the microwave heat treatment apparatus 1 may be used for supplying gas into the upper second chamber S21 instead of the gas supplying device 5 a.

The purging gas is directly introduced from the gas introducing unit 126B into the lower second chamber S22. The purging gas introduced into the lower second chamber S21 is diffused from the lower second chamber S22 into the first chamber S1 through the plurality of gas holes 107a of the partition 107 to purge atmosphere inside the first chamber S1. The exhaustion from the first chamber S1 is performed through the exhaust port 12b. Further, gas introduction into the lower second chamber S22 may be performed by using, for example, a shower head method having a plurality of gas injection ports without being limited to a side flow method in which gas are introduced through the side wall portion 12. Further, an external gas supplying devices which is not included in the configuration of the microwave heat treatment apparatus 1A may be used for supplying gas into the lower second chamber S22 instead of the gas supplying device 5a.

[Processing Sequence]

A processing sequence at the time of performing the annealing process on the wafer W in the microwave heat treatment apparatus 1A is the same as that in the first embodiment except that the purging gas is introduced from the respective gas introducing units 126A and 126B into the respective upper and lower second chambers S21 and S22.

In the microwave heat treatment apparatus 1A of the present embodiment, the purging gas is introduced into the respective upper and lower second chambers S21 and S22 to diffuse the purging gas from the upper and lower second chambers S21 and S22 into the first chamber S1 through the plurality of gas holes 7a and 107a of the partitions 7 and 107 to purge the atmosphere of the first chamber S1.

In the microwave heat treatment apparatus 1A, a pair of upper and lower partitions 7 and 107 may be provided to make a volume of the first chamber S1 smaller as compared to the microwave heat treatment apparatus 1 of the first embodiment. During the purging process, a volume substantially required to be subjected to substitution of atmosphere is the volume of the first chamber S1 and thus, the purging process may be completed in a short time as compared to a case of purging the entirety of the processing container 2. Further, the upper second chamber S21 and the lower second chamber S22 are disposed to sandwich the first chamber S1 in a vertical direction and the purging gas is diffused through the gas holes 7a and 107a of the partitions 7 and 107 and thus, the purging efficiency of the first chamber S1 may be increased. Further, a total flow rate of the purging gas required for the purging process may be largely reduced as compared to a case of purging the entirety of the internal space of the processing container. Furthermore, it becomes possible to implement an efficient purging process and thus, it does not need to make the internal space of the processing container 2 a high-vacuum state. Accordingly, minimum vacuum facility is enough for the microwave heat treatment apparatus 1A.

Further, in the microwave heat treatment apparatus 1A, a small amount of the purging gas may be consecutively introduced from the gas introducing units 126A and 126B all the time, for example, during the carrying-in and/or carrying-out operation of the wafer W or during performing the annealing process on the wafer W without being limited to the purging process during which the purging gas is introduced from the gas introducing units 126A and 126B at a predetermined flow rate. The relationship of C2>C1 may be maintained, on the assumption that the concentration of the purging gas in the first chamber S1 is set to C1 and the concentration of the purging gas in the upper and lower second chambers S21 and S22 is set to C2, by consecutively introducing a small amount of the purging gas into the respective upper second chamber S21 and lower second chamber S22. By doing this, oxygen mixed into the processing container 2 from outside of the processing container 2 is prevented from being diffused from the first chamber S1 into the upper and lower second chambers S21 and S22 through the gas holes 7a and 107a.

Other configuration and effect in the microwave heat treatment apparatus 1A of the present embodiment are the same as those of the microwave heat treatment apparatus 1 of the first embodiment and thus, descriptions thereof will be omitted. Further, also in the microwave heat treatment apparatus 1A, it is possible for the gas holes 7a and 107a of the partitions 7 to have a diaphragm function (see, FIGS. 3A and 3B). In this case, the gas holes 7a and 107a may be formed in such a manner the flow path resistance of the gas holes 7a and 107a is increased from the upper and lower second chambers S21 and S22 toward the first chamber S1.

### Third Embodiment

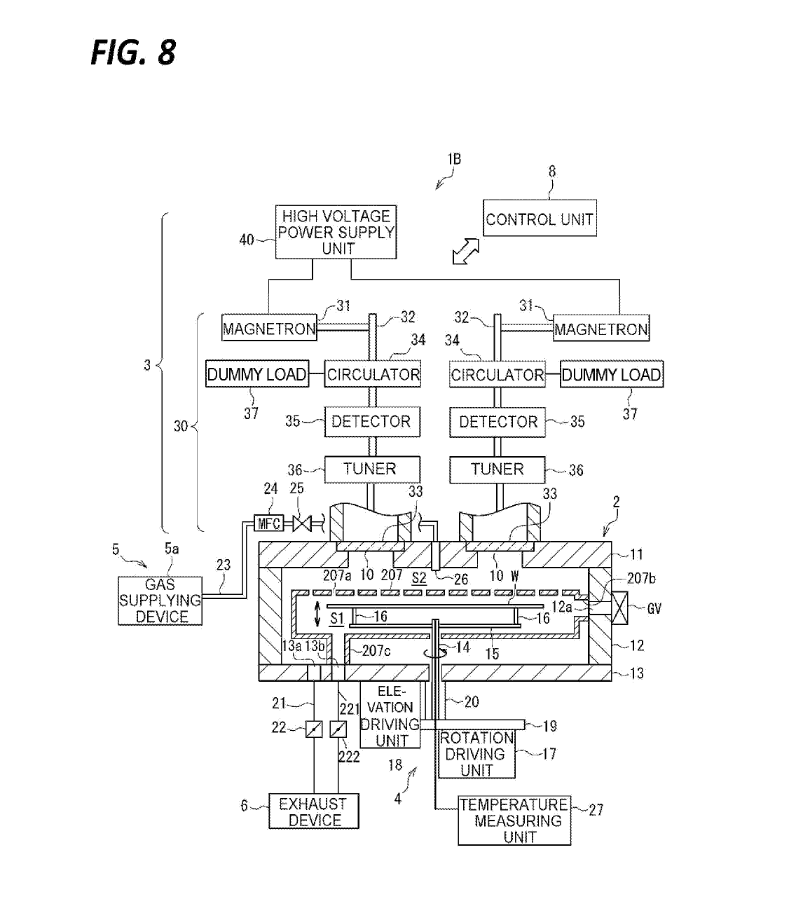

Next, a microwave heat treatment apparatus 1B according to a third embodiment of the present disclosure will be described with reference to FIG. 8. FIG. 8 is a cross sectional view illustrating a schematic configuration of a microwave heat treatment apparatus 1B according to the present embodiment. The microwave heat treatment apparatus 1B according to the present embodiment is an apparatus which performs an annealing process by irradiating microwaves onto, for example, a wafer W for manufacturing a semiconductor device through a series of consecutive operations. In the following description, mainly the difference between the microwave heat treatment apparatus 1B and the microwave heat treatment apparatus 1 of the first embodiment will be described. In FIG. 8, like reference numerals are given to the same components as those of the microwave heat treatment apparatus 1 of the first embodiment, and descriptions thereof will be omitted.

In the microwave heat treatment apparatus 1B of the present embodiment, the dielectric partition is provided to surround the top, the bottom, the left and the right of the wafer W which is being supported by the supporting pin 16. That is, the microwave heat treatment apparatus 1B includes partition 207 which surrounds the periphery of the wafer W supported by the supporting pin 16. The partition 207 includes a plurality of gas holes 207a. The plurality of gas holes 207a are provided on a region which opposes at least the top surface of the wafer W in the partition 207. A material of the partition 207 is the same as that of the partition 7 in the first embodiment and the configuration of the gas holes 207a is the same as that of the gas holes 7a in the partition 7 of the first embodiment. Further, the plurality of gas holes 207a may be provided over the entire region of the partition 207.

The processing container 2 of the microwave heat treatment apparatus 1B of the present embodiment includes therein a first chamber S1 in which the wafer W surrounded by a partition 207 is accommodated and a second chamber S2 defined by the partition 207 and the processing container 2 in the outside of the first chamber 51.

The first chamber 51 is defined by the partition 207. The partition 207 is fixed to the side wall portion 12 of the processing container 2. An opening portion 207b is provided on one side of the partition 207. The opening portion 207b is formed at a position which communicates with the carrying-in/carrying-out port 12a which corresponds to an opening formed in the processing container 2 for carrying-in/carrying-out the wafer W and allows the wafer W to be carried into/out of the first chamber S1 among the partition 207.

The second chamber S2 is defined by the partition 207, the ceiling portion 11, the side wall portion 12 and the bottom portion 13 of the processing container 2. The second chamber S2 is formed to surround the first chamber S1. As such, the internal space of the processing container 2 is divided into two by the partition 207. Further, the exhaust port 13b is provided at the bottom portion 13 separately from the exhaust port 13a.

Further, the partition 207 includes the exhaust path 207c in the microwave heat treatment apparatus 1B of the present embodiment. The exhaust path 207c is connected to the exhaust port 13b formed in a space spanning from the lower portion of the partition 207 to the bottom portion 13 of the processing container 2. The microwave heat treatment apparatus 1B further includes an exhaust pipe 221 which connects the exhaust port 13b and the exhaust device 6 and a pressure control valve 222 provided on the way of the exhaust pipe 221. Atmosphere inside the first chamber S1 may be discharged to outside of the processing container 2 through the exhaust path 207c and the exhaust port 13b without passing through the second chamber S2.

Similarly to the first embodiment, the microwave heat treatment apparatus 1B of the present embodiment is configured such that the purging gas may be directly introduced into the second chamber S2 through the gas introducing unit 26. The purging gas introduced into second chamber S2 is diffused from the second chamber S2 into the first chamber S1 through the plurality of gas holes 207a of the partition 207 to purge atmosphere of the first chamber S1. Further, gas introduction into the second chamber S2 may be performed by using, for example, a shower head method in which gas are introduced from a plurality of gas injection ports or a side flow method in which gas are introduced from the side wall portion 12. Further, an external gas supplying devices which is not included in the configuration of the microwave heat treatment apparatus 1B may be used for supplying gas into the second chamber S2 instead of the gas supplying device 5a.

[Processing Sequence]

A processing sequence at the time of performing the annealing process on the wafer W in the microwave heat treatment apparatus 1B is the same as that in the first embodiment

The purging gas is introduced from the gas introducing unit 26 into the second chamber S2 in the microwave heat treatment apparatus 1B. Also, the purging gas is diffused from the second chamber S2 into the first chamber S1 through the plurality of gas holes 207a of the partition 207 and discharged through the exhaust path 207c and the exhaust port 13b to purge the atmosphere of the first chamber S1.

In the microwave heat treatment apparatus 1B, the partition 207 surrounding the wafer W may be provided to make a volume of the first chamber S1 smaller than the microwave heat treatment apparatus 1 of the first embodiment. During the purging process, a volume substantially required to be subjected to substitution of atmosphere is the volume of the first chamber S1 and thus, the purging process may be completed in a short time as compared to a case of purging the entirety of the processing container 2. Further, a total flow rate of the purging gas required for the purging process may be largely reduced as compared to a case of purging the entirety of the internal space of the processing container.

Further, in the microwave heat treatment apparatus 1B, a small amount of the purging gas may be consecutively introduced from the gas introducing unit 26 into the second chamber S2 all the time, for example, during the carrying-in and/or carrying-out operation of the wafer W or during performing the annealing process on the wafer W without being limited to the purging process during which the purging gas is introduced from the gas introducing unit 26 at a predetermined flow rate. As such, the relationship of C2>C1 may be maintained, on the assumption that the concentration of the purging gas in the first chamber S1 is set to C1 and the concentration of the purging gas in the second chambers S2 is set to C2, by consecutively introducing a small amount of the purging gas into the second chamber S2. Accordingly, oxygen mixed into the processing container 2 from outside of the processing container 2 is prevented from being diffused from the first chamber S1 into the second chamber S2 through the gas holes 207a.

Other configurations and effects in the microwave heat treatment apparatus 1B of the present embodiment are the same as those of the microwave heat treatment apparatus 1 of the first embodiment and thus, descriptions thereof will be omitted.

### Fourth Embodiment

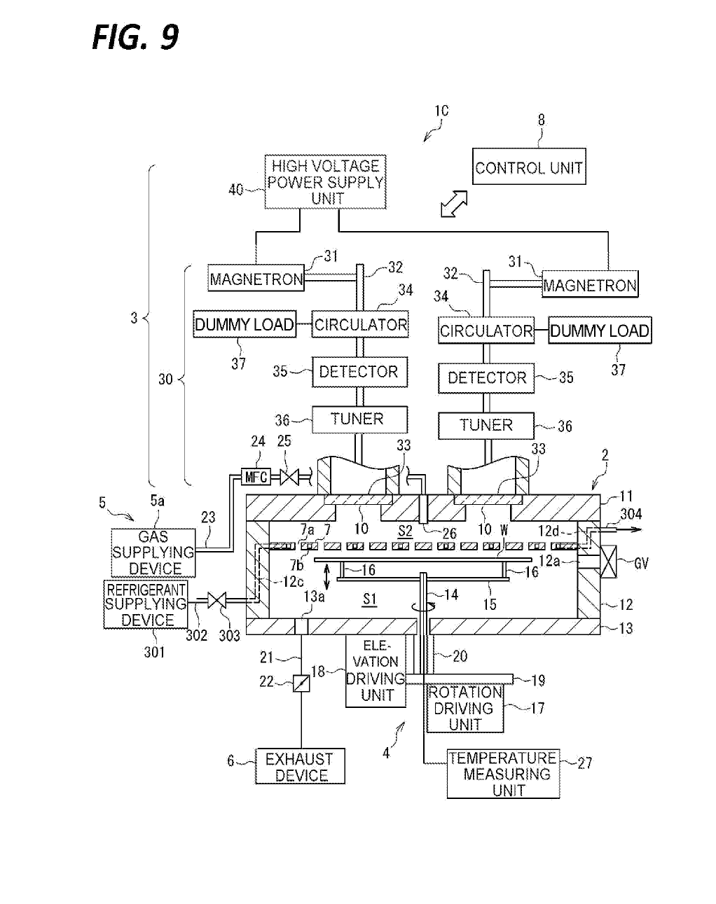

Next, a microwave heat treatment apparatus 1C according to a fourth embodiment of the present disclosure will be described with reference to FIG. 9. FIG. 9 is a cross sectional view illustrating a schematic configuration of a microwave heat treatment apparatus 1C according to the present embodiment. The microwave heat treatment apparatus 1C according to the present embodiment is an apparatus which performs an annealing process by irradiating microwaves onto, for example, a wafer W for manufacturing a semiconductor device through a series of consecutive operations. In the following description, mainly the difference between microwave heat treatment apparatus 1C and the microwave heat treatment apparatus 1 of the first embodiment will be described. In FIG. 9, like reference numerals are given to the same components as those of the microwave heat treatment apparatus 1 of the first embodiment, and descriptions thereof will be omitted.

The microwave heat treatment apparatus 1C of the present embodiment includes a cooling mechanism, which cools down the purging gas and the wafer W, provided at the dielectric partition. That is, the microwave heat treatment apparatus 1C includes a coolant supplying device 301 and the partition 7 having a flow path structure adapted to flow the coolant from the coolant supplying device 301. The partition 7 is provided above the wafer W supported by the supporting pin 16. The partition 7 includes the plurality of gas holes 7a. The plurality of gas holes 7a are provided on a region which faces at least the top surface of the wafer W in the partition 7. The material of the partition 7 or the configuration of the gas hole 7a is the same as that of the partition 7 or the gas holes 7a of the first embodiment.

In the microwave heat treatment apparatus 1C of the present embodiment, the flow path 7b is provided within the partition 7. The flow path 7b is formed in a mesh shape vertically and horizontally in order to avoid the gas holes 7a in the partition 7. The microwave heat treatment apparatus 1C further includes a piping 302 for supplying the coolant from the coolant supplying device 301 to the flow path 7b and a valve 303 provided on the way of the piping 302 for supplying the coolant.

Further, in the microwave heat treatment apparatus 1C of the present embodiment, the flow path 12c for supplying the coolant from the coolant supplying device 301 to the flow path 7b of the partition 7 and the flow path 12d for circulating the coolant from the flow path 7b in the coolant supplying device 301 are provided inside of the side wall portion 12. Further, the microwave heat treatment apparatus 1C of the present embodiment includes the piping 304 for circulating the coolant and connected to the flow path 12d. Although illustration is omitted, the piping 304 for circulating the coolant is connected to the coolant supplying device 301.

With the configuration described above, in the microwave heat treatment apparatus 1C of the present embodiment, the coolant from the coolant supplying device 301 may be circulated through the piping 302 for supplying the coolant, the flow path 12c within the side wall portion 12, the flow path 7b within the partition 7, a flow path 12d within the side wall portion 12 and a piping 304 for circulating the coolant. By doing this, the purging gas may be cooled down at the time when the purging gas passes through the gas holes 7a of the partition 7 and the wafer W may be cooled down using the purging gas cooled down as described above. Further, the present embodiment is configured such that the wafer W may be cooled down by the cooled partition 7.

A coolant having a property of transmitting microwaves is desirable as a coolant to be supplied from the coolant supplying device 301 to the flow path 7b. Especially, it is more desirable to use a coolant having a high microwave transmissivity of, such as 2.45 GHz or 5.8 GHz in the present embodiment. Fluorine-based coolant, for example, galden (perfluoropolyether) may be used as the coolant transmitting the microwaves having the frequency.

The partition 7 having cooling function is provided in the microwave heat treatment apparatus 1C of the present embodiment and thus, an effect of cooling down the wafer W may be expected, in addition to operational effects of the microwave heat treatment apparatus 1 of the first embodiment.

Other configurations and effects in the microwave heat treatment apparatus 1C of the present embodiment are the same as those of the microwave heat treatment apparatus 1 of the first embodiment and thus, descriptions thereof will be omitted. Further, the cooling mechanism of the present embodiment may also be applied to the microwave heat treatment apparatus 1A of the second embodiment and the microwave heat treatment apparatus 1B of the third embodiment.

Further, the present disclosure is not limited to the embodiments described above and various modifications may be made thereto. For example, the embodiments described above have a configuration in which the purging gas is introduced only into the second chambers S2, S21 and S22. However, the embodiments may be configured in such a manner that the purging gas introducing unit is also provided in the first chamber S1 and the purging gas is introduced into the first chamber S1 while the purging gas are introduced into the second chambers S2, S21 and S22 in order to reduce the purging process by increasing the efficiency of the purging process.

Further, the microwave heat treatment apparatus of the present disclosure may also be applied to the microwave heat treatment apparatus which uses a substrate of a solar cell panel or a substrate for a flat panel display as a target object to be processed without being limited to a case where a semiconductor wafer as a target object to be processed. Further, the number of microwave units 30 (the number of magnetrons 31) in the microwave heat treatment apparatus or the number of microwave introducing ports 10 is not limited to the number described in the embodiments.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A microwave heat treatment apparatus, comprising:
a processing container having a top wall, a bottom wall and sidewalls, and configured to accommodate a target object to be processed;
a microwave introducing device configured to generate microwaves for heating the target object to introduce the microwaves into the processing container;
a purging gas introducing unit configured to introduce a purging gas into the processing container;
a support member configured to support the target object in the processing container; and
a dielectric partition disposed between the support member and the purging gas introducing unit and provided with a plurality of gas holes through which the purging gas is transmitted,
wherein, an internal space of the processing container is divided, by the dielectric partition and the processing container, into at least a first chamber in which the target object is accommodated and a second chamber into which the purging gas is directly introduced by the purging gas introducing unit, and is configured such that the purging gas introduced into the second chamber is diffused from the second chamber into the first chamber through the gas holes of the dielectric partition to purge atmosphere within the first chamber.

2. The microwave heat treatment apparatus according to claim 1, wherein C2 is larger than C1 on the assumption that a concentration of the purging gas of the first chamber is set to C1 and a concentration of the purging gas of the second chamber is set to C2 during introduction of the purging gas from the purging gas introducing unit.

3. The microwave heat treatment apparatus according to claim 1, wherein the dielectric partition is provided above the support member.

4. The microwave heat treatment apparatus according to claim 1, wherein the dielectric partition is provided above and below the support member,
the inner space of the processing container is divided into a first chamber in which the target object is accommodated, an upper second chamber defined by a dielectric partition provided above the target object and the processing container and a lower second chamber defined by a dielectric partition provided below the target object and the processing container, and
the purging gas introducing unit which introduces the purging gas is provided at the upper second chamber and the lower second chamber.

5. The microwave heat treatment apparatus according to claim 1, wherein the dielectric partition is provided to surround the top, the bottom, the left and the right of the target object and includes an opening portion, and
the opening portion is formed to communicate with an opening formed in the processing container in order to carry-in and carry-out the target object to and from the first chamber.

6. The microwave heat treatment apparatus according to claim 1, wherein the gas holes are provided at least at a region facing the target object in the dielectric partition.

7. The microwave heat treatment apparatus according to claim 1, further comprising a flow path which allows coolant to flow and provided within the dielectric partition.

8. The microwave heat treatment apparatus according to claim 1, wherein the dielectric partition is made of quartz.

9. The microwave heat treatment apparatus according to claim 1, wherein the top wall of the processing container includes a plurality of microwave introducing ports which introduce microwaves generated in the microwave introducing device into the processing container.

10. A processing method in which a target object to be processed is heated using a microwave heat treatment apparatus, which includes a processing container which has a top wall, a bottom wall and side walls and accommodates the target object, a microwave introducing device which generates microwaves for heating the target object and introduces the microwaves into the processing container, a purging gas introducing unit which introduces a purging gas into the processing container, a support member which supports the target object in the processing container, a dielectric partition disposed between the support member and the purging gas introducing unit and provided with a plurality of gas holes transmitting the purging gas, and an internal space of the processing container is divided, by the dielectric partition and the processing container, into at least a first chamber in which the target object is accommodated and a second chamber into which the purging gas introduced by the purging gas introducing unit,
the method comprising:
a purging process of purging atmosphere inside of the first chamber by diffusing the purging gas into the first chamber through the gas holes of the dielectric partition, the purging gas being introduced into the second chamber by introducing the purging gas from the purging gas introducing unit into the second chamber; and
an annealing process of heating the target object by introducing microwaves into the processing container by the microwave introducing device while diffusing the purging gas introduced into the second chamber into the first chamber through the gas holes of the dielectric partition, the purging gas being introduced from the purging gas introducing unit into the second chamber.

11. The processing method according to claim 10, wherein C2 is larger than C1 on the assumption that a concentration of the purging gas of the first chamber is set to C1 and a concentration of the purging gas of the second chamber is set to C2 in the purging process and the annealing process.

12. The processing method according to claim 10, wherein the purging process is performed each time when the target object is carried into/out of the processing container to sequentially process a plurality of target objects.
